(19) United States
(12) Patent Application Publication
(10) Pub. No.: US 2009/0208747 A1
(43) Pub. Date: Aug. 20, 2009

(54) Novel Crystalline Methods and Novel Crystalline and Amorphous forms of Halogenated Sugars

(75) Inventors: Rakesh Ratnam, Karnataka (IN); Chandrashekar Batchu, Karnataka (IN); Andanagouda Patil, Karnataka (IN); Sundeep Aurora, Karnataka (IN)

Correspondence Address: THE NATH LAW GROUP, 112 South West Street, Alexandria, VA, 22314, US

(73) Assignee: V.B. MEDICARE PVT. LTD, BANGALORE (IN)

(21) Appl. No.: 12/225,378

(22) PCT Filed: Mar. 21, 2007
(86) PCT No.: PCT/IN2007/000118

§ 371 Date: Sep. 19, 2008

(30) Foreign Application Priority Data
Mar. 22, 2006 (IN) 405/MUM/2006

(51) Int. Cl. C13K 13/00; B32B 5/16

(52) U.S. Cl. 428/402; 536/123.13

(57) ABSTRACT

Disclosed is crystalline 4,1′,6′Trichlorogalactosucrose (TGS) having enhanced storage stability, a mean particle size of about 5 microns or less, 90% particles being less than about 10 microns and the maximum particle size being more than twice the mean but less than about 35 microns; and a process for producing the same comprising gradual cooling of a saturated solution of TGS of a mixture of a a polar alcoholic solvent and a less polar organic solvent, the proportion of the said polar alcoholic solvent being within maintained within a range of about 3% to 10% of total volume of the said saturated solution during cooling process.

### TECHNICAL FIELD

The present invention relates to methods of separation of solid form from their solutions used in the production of halo (chlorinated) sugars including 1′-6′-Dichloro-1′-6′-DIDEOXY-β-Fructofuranasyl-4-chloro-4-deoxy-galactopyranoside (TGS) and various solid forms of this product.

### BACKGROUND OF THE INVENTION

Strategies of prior art methods of production of 4,1′,6′ trichlorogalactosucrose (TGS) predominantly involve chlorination of sucrose-6-ester by use of Vilsmeier-Haack reagent derived from various chlorinating agents such as phosphorus oxychloride, oxalyl chloride, phosphorus pentachloride etc, and a tertiary amide such as dimethyl formamide (DMF) or dimethyl acetamide to chlorinate Sucrose-6-ester, to form 6 acetyl 4,1′,6′trichlorogalactosucrose. After the said chlorination reaction, the reaction mass is neutralized to pH 7.0-7.5 using appropriate alkali hydroxides of calcium, sodium, etc. to deesterify/deacetylate the 6 acetyl 4,1′,6′trichlorogalactosucrose to form 4,1′,6′ trichlorogalactosucrose (TGS), which is a high intensity sweetener.

This specification covers a novel crystallization process where the n-butanol/methanol mixture is used in suitable proportions to facilitate formation of crystallized as well as amorphous solid forms of TGS with mean particle size of about or less than 5. The purification steps for the isolation of the TGS involve various processes including extractive purification, Affinity chromatography, etc. After the final purification of TGS, which is substantially free from all organic impurities as well as inorganic solids, is subjected to crystallization by suitable methods.

Jackson (1990) in U.S. Pat. No. 4,918,182 found that the thermal stability of large crystal size of dry crystalline TGS is unsatisfactory. They also fond that same can be considerably enhanced by reducing the particle size and limiting the size distribution. Their finding was that in practice the mean particle size should be half the maximum particle size and is desirable no more than 10 microns; Preferably the mean dimension should be about 5 microns or less and the maximum dimension is about 10 microns or less, for example a mean of about 3 microns. They pointed out that by conventional methods crystals obtained are of dimensions of from 80 microns length up to about 800 microns when crystallized from aqueous solutions and of 15×5 microns crystals when crystallized from organic solvent such as ethyl acetate. They also acknowledged that it is possible to obtain relatively small crystals of TGS by choosing the appropriate conditions for crystallization, however, it is difficult to control the crystallisation process to produce small particles of a small size distribution and crystallisation from organic solvents may leave undesirable solvent residues in the product. It was also pointed out that the particle size of the crystalline material can be reduced by mechanical grinding but it is difficult to achieve a very small particle size by this means. They achieved the task in their invention by jet milling and claimed crystalline TGS having a mean particle size of at most 10 microns, the maximum particle size being no more than twice the mean that has enhanced thermal stability. However, adding one more post-crystallization process adds to the cost of production. Thus, a method of direct production of stable crystals during process of crystallization itself without a need of post-crystallization process was needed.

Catani et al (2005) in U.S. Pat. No. 6,943,248 have reported use of a recirculation model in aqueous crystallization which achieved stable crystals without any post-crystallization process; the particle size achieved was such that 90 wt. % of the sample had a particle size less than 62 micron while 10 wt. % has a particle size less than from about 4 micron with a mean of 30 micron. The method of this recirculation comprised introducing a feed stream of TGS solution into a system comprising a crystallization vessel, a heat exchanger, and a pump configured to recirculate the TGS solution out of and back into the crystallizer vessel and through the heat exchanger; causing TGS crystals to form continuously in the system; removing an output stream of TGS solution including TGS crystals from the system; and continuously recirculating a part of the output stream including TGS crystals to the crystallization vessel, and separating TGS crystals from the remaining part of the output stream; wherein the rates of introducing, removing, and recirculating are controlled so that TGS passing through the system has, on average, a residence time in the system of at least four hours but which may also extend to 24 hours or more; and drying the separated TGS crystals at a drying temperature of about 85° F. or below. It is evident that this is a very complex to control and equipment intensive model. Further, Catani et al acknowledge that the shelf life of the dried TGS crystals of their invention is higher but has a somewhat higher sensitivity to drying conditions than do prior art crystals, and a greater sensitivity to the amount of moisture retained in them.

Microcrystalline TGS having average particle size of about 12 microns to about 8 microns made by Agitated Thin Film Dryer and amorphous TGS having average particle size of about 8 microns to 5 microns made by spray drying and reported by Ratnam et al. (2005) in (WO 2005/90374). This was a far simpler model than the model of Catani et al (2005) in providing a method of getting stable TGS particles where no post crystallization process, including grinding or a jet milling process was involved here in getting small particle size. There are, however, limitations to the scope of scale up of these methods and they are more tedious to control and involves substantial expense in equipment as well as energy expenditure for removing large volume of solvents.

### SUMMARY OF INVENTION

This invention discloses a process of crystallization of TGS which provides an easy control on getting stable crystalline TGS.

This invention also discloses crystalline TGS having a mean particle size of around 5 micron or less, 90% of particles very close to or less than 10 microns and maximum particle size not exceeding 35 microns.

An embodiment of this invention is a surprising finding that TGS of average particle size of 5 micron or less, maximum particle size of about 35 micron gets crystallized directly from solution when a TGS solution in a solvent mixture of a polar alcoholic solvent and a less polar organic solvent is concentrated by distillation under reduced pressure to reach a saturation of TGS, and thereafter temperature of the saturated solution is gradually reduced from about 55° C. to about −5° C. over a period of time of more than 1 hour at least making it sure that a small proportion of the

said polar alcoholic solvent is always present in the crystallizing composition by periodic testing and adding more polar alcoholic solvent to keep the proportion above critical level; cooling rapidly in one hour or less resulted in no crystallization.

It was also further found that time required to achieve same mean particle size and same particle size distribution decreases as polarity of the less polar higher alcoholic solvent goes on decreasing in the said solvent mixture used for getting TGS dissolved.

The polar alcoholic solvent may include methanol or ethanol and the higher and less polar alcoholic solvent may include, without limiting to one or more of n-propanol, Iso butanol, t-butanol, secondary butanol, pentanol, Amyl alcohol, and the like.

Crystalline TGS that could be made by the process of this invention was seen to have a mean particle size of about 5 micron or less and maximum particle size less than about 35 microns.

With methanol:ethyl acetate mixture having dissolved TGS and brought to saturation level by distilling under reduced pressure at about 55° C., the solution was cooled from 55° C. to 30° C. in about 16 hours, then from 30° C. to 15° C. in about 6 hours and then further cooled to −5° C. in about 60 minutes. In methanol:butanol the vacuum distilled solution was cooled from 55° C. to 30° C. in about 4-6 hours, then from 30° C. to 15° C. in about 2 hours and then further cooled to −5° C. in about 3.5 hours. Thus, considerably less period of cooling was possible by using butanol in the solvent mixture with methanol.

Minimum level of a polar alcoholic solvent needed to be maintained was observed to be between about 3% to 10, although on both sides of this ratio, crystallization will occur.

It is obvious to a person skilled in the art that the period of cooling after one hour and steps of cooling with respect to range of temperatures and rate of cooling mentioned above are only illustrative and do not limit the scope of the invention; more the period taken, larger shall the crystal size and larger the quantity of crystals recovered and it is a function of selecting a degree of stability as a criterion to select the best suited schedule. It is possible to experiment with other schedules and solvent combinations with a polar alcoholic solvent to achieve smaller average particle size, smaller size of largest particle size, achieving near 100% particles below 10 microns and narrower particle size distribution keeping the yield of crystals also within practically acceptable limit.

The slurry of crystalline TGS is washed free of polar alcoholic solvent by using an ester solvent such as ethyl acetate, butyl acetate, etc at reduced temperature preferably of −5° to 15° C. to ensure limiting carryover of methanol to well below maximum permissible limit. Carryover of methanol may also be avoided by using ethanol instead of methanol which gives same results as using methanol as a polar alcoholic solvent in this invention.

It is also an embodiment of this invention that crystalline TGS of this invention is found to be stable in storage for one year.

An amorphous form prepared by spray drying a methanol:Isopropanol (1:1) solution of TGS having particle size not exceeding 14 microns microns and average particle size of about 2.5 microns was found to be stable for at least one year in storage and its stability is better even than the small crystals of this invention. Thus, lesser the mean particle size, better is the stability.

For extrapolating potential storage stability beyond one year, an accelerated storage stability test was conducted. The results show that assay of large particle size crystalline TGS declined by 1.2% in first three days and by 1.87% by fifth day; difference in pH was not substantial. In small particle size crystalline TGS, percent assay as well as pH were stable. This indicated enhanced stability for small particle size crystalline TGS produced in this invention. Amorphous form with average particle size of about 3 micron also showed excellent stability as decline in percent assay was only 0.08% and decline in pH was only 0.08 units over a period of three days. A three days' stability under accelerated test is considered equivalent to a storage stability of 8 years at the ambient.

### BRIEF DESCRIPTION OF FIGURES

FIG. 1: Depicts the histogram of the particle size distribution of Crystalline TGS obtained from Example 2 (small Mean Particle Size)

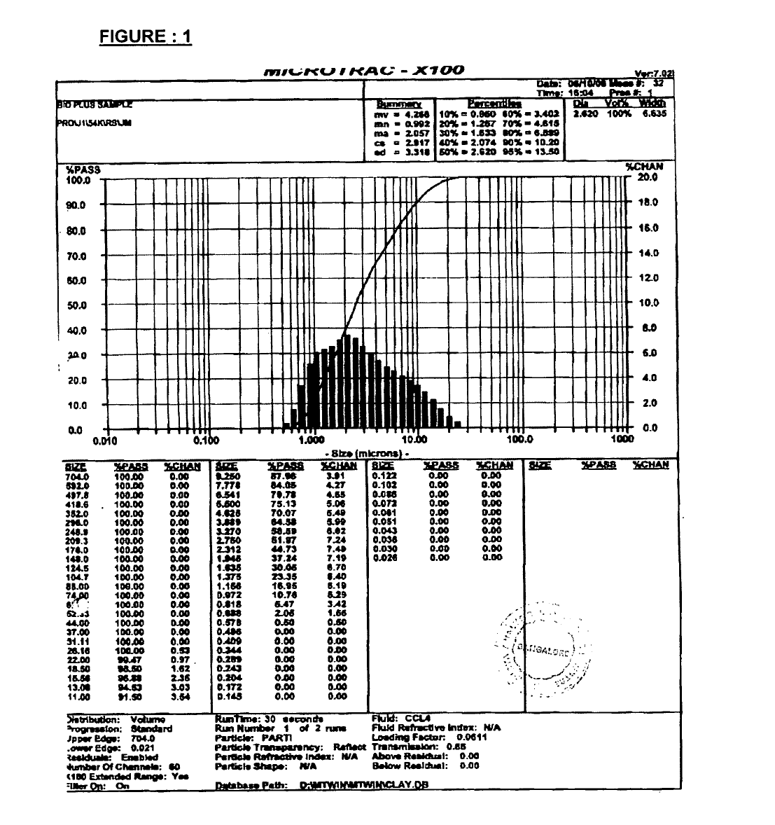

FIG. 2: Depicts histogram of particle size distribution of the amorphous product obtained from Example 3. (Smaller Mean Particle Size)

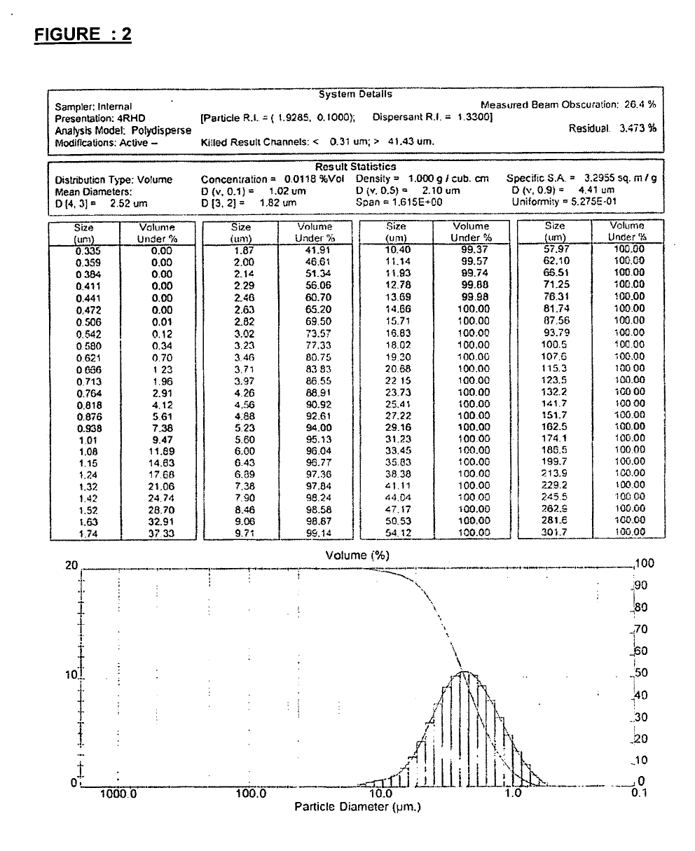

### DETAILED DESCRIPTION OF THE INVENTION

Embodiments of this invention include (a) a process of crystallization directly producing stable TGS crystals, (b) the said crystalline TGS having a mean particle size of around 5 micron or less, 90% of particles being very close to or less than 10 microns and maximum particle size not exceeding 35 microns.

The process of this invention of crystallization of TGS provides an easy control on getting stable crystalline TGS.

This invention also discloses crystalline TGS having a mean particle size of around 5 micron or less, 90% of particles very close to or less than 10 microns and maximum particle size not exceeding 35 microns. This particle size distribution is very typical of the process of invention here, is novel because it is stable and is different than the stable crystalline TGS of mean particle of at the most 10 micron and maximum particle size being not exceeding twice the mean as claimed by Jackson et al (1990) and stable crystalline TGS produced by crystallization in a recirculation model, said TGS having 90 wt. % of the sample with a particle size less than 62 micron 10 wt. % has a particle size less than from about 4 micron and with a mean of 30 micron as disclosed by Catani et al (2005), referred above.

An embodiment of this invention is a surprising finding that TGS of average particle size of 5 micron or less, maximum particle size of about 35 micron and 90% particles being very close to or less than 10 microns gets crystallized directly from solution when a TGS solution in a solvent mixture of a polar alcoholic solvent and a less polar organic solvent is concentrated by distillation under reduced pressure to reach a saturation of TGS, and thereafter temperature of the saturated solution is gradually reduced from about 55° C. to about −5° C. over a period of time of more than 1 hour at least making it sure that a small proportion of the said polar alcoholic solvent is always present in the crystallizing composition by periodic testing and adding more polar alcoholic solvent to keep the proportion above critical level; cooling rapidly in one hour or less resulted in no crystallization.

One embodiment of this invention is starting crystallization of TGS with its solution in a mixture of one polar alcoholic solvent and at least another less polar organic solvent. Proportion of the two solvents is not critical as long as at least about 3% to 10% of the mixture is provided by the polar alcoholic solvent, which in actual practice is achieved by periodic testing and adding polar alcoholic solvent to make up its deficit, if any, to maintain its critical level. The preferred alcoholic solvent may, without a limitation, either be methanol or ethanol and the less polar solvent may, without a limitation, be one or more of ethyl acetate, n-propanol, Iso butanol, t-butanol, secondary butanol, pentanol, Amyl alcohol, methyl ethyl ketone, butyl acetate, acetone, Methylene dichloride and the like.

TGS may be specifically dissolved in the solvent mixture of this invention as pure crystals, or may be purified after dissolution by applying known methods of purification including column chromatography, charcoalization and the like. In one embodiment of this invention, the feed for crystallization is provided by the elution for TGS from an affinity chromatography column packed with ADS600 from Thermax as an adsorbent in 1:1 methanol:butanol as eluent. The eluted out solution of TGS is charcoalized and subjected to distillation under reduced pressure. The distillation is carried out preferably at around 55° C. The distillation is continued until bulk of methanol and butanol are removed. When started as a about 5% solution of TGS in 1:1 solution in methanol:butanol, when a level of saturation of TGS is reached, concentration of TGS is about 55% in the solution and methanol is around 3 to 10% in the solvent mixture. As soon as some crystals start falling out at this point, distillation under reduced pressure is discontinued and the phase of slow reduction in temperature is started.

Period required for crystallization varied with the polarity of the less polar organic solvent used. This period shortened with decrease in polarity of the less polar organic solvent.

Thus, with 1:1 methanol:ethyl acetate mixture having dissolved TGS to about 5% level initially and brought to saturation level by distilling under reduced pressure at about 55° C., for achieving crystalline TGS of this invention, the solution was cooled from 55° C. to 30° C. in about 16 hours, then from 30° C. to 15° C. in about 6 hours and then further cooled to −5° C. in about 60 minutes. In case of starting 5% solution of TGS in 1:1 methanol:butanol, after vacuum distillation to achieve saturation level, the solution was cooled from 55° C. to 30° C. in about 4-6 hours, then from 30° C. to 15° C. in about 2 hours and then further cooled to −5° C. in about 3.5 hours. Thus, considerably less of total period of cooling was possible by using butanol in the solvent mixture with methanol in place of ethyl acetate.

Minimum level of a polar alcoholic solvent needed to be maintained was observed to be between about 3% to 10, although on both sides of this ratio, crystallization will occur.

It is obvious to a person skilled in the art that the period of cooling after one hour and steps of cooling with respect to range of temperatures and rate of cooling mentioned above are only illustrative and do not limit the scope of the invention; more the period taken, larger shall the crystal size and larger the quantity of crystals recovered and it is a function of selecting a degree of stability as a criterion to select the best suited schedule. If respective solvent mixtures are cooled with longer periods of cooling, the crystals grew to about 150 microns or more, which was not preferable. Thus, it is necessary to select a schedule of cooling which shall balance the desired particle size distribution as well as yield of the crystals.

The slurry of crystalline TGS obtained was then filtered and slurry washed with 1:0.5 to 1:1.2 more preferably 1:0.5-0.7 w/v of ester solvent such as ethyl acetate, butyl acetate, etc at reduced temperature of −5° to 15° C. to ensure carryover of methanol well below maximum permissible limit. Carryover of methanol may also be avoided by using ethanol instead of methanol which gives same results as using methanol as a polar alcoholic solvent in this invention.

The solids obtained were subjected to drying operation below 45° C. under vacuum. The resultant product was analyzed for particle size and was found to be 90% less than 10 microns respectively.

It is possible to experiment with other schedules and solvent combinations with a polar alcoholic solvent to achieve smaller average particle size, smaller size of largest particle size, achieving near 100% particles below 10 microns and narrower particle size distribution than reported here keeping the yield of crystals also within practically acceptable limit.

Being a batch operation of crystallization, method of this invention is easy to control and convenient.

It is also an embodiment of this invention that crystalline TGS of this invention is found to be stable in storage for one year. Stability testing was done as per ICH Harmonised Tripaertite Guideline Stability Testing of New drug substances and Products Q1A(R2) issued by International Conference on Hamonization of technical requirements for registration of pharmaceuticals for human use and recommended for adoption at Step 4 of the ICH Process on 6 Feb. 2003 by the ICH Steering Committee.

An amorphous form prepared by spray drying a methanol:Isopropanol (1:1) solution of TGS having particle size not exceeding 14 microns and average particle size of about 2.5 microns was found to be stable for at least one year in storage and its stability is better even than the small crystals of this invention. Thus, it was clear that small particle size with as much narrower distribution as possible is critically desirable from the point of view of stability of TGS.

For extrapolating potential storage stability beyond one year, an accelerated storage stability test was conducted. In this test, crystalline TGS of small and large mean particle size was incubated at 50° C. in sealed containers. Percent assay and pH were tested after each 24 hours for five successive days. The results show that assay of large particle size crystalline TGS declined by 1.2% in first three days and by 1.87% by fifth day; difference in pH was not substantial. In small particle size crystalline TGS, percent assay as well as pH were stable. This indicated enhanced stability for small particle size crystalline TGS produced in this invention. The amorphous form, which had least average particle size of about 3 micron, showed excellent stability wherein in three days, decline in percent assay was 0.08% and decline in pH was by 0.08 units. A three days' stability in accelerated stability test is extrapolated by Catani et al (2005) to 8 years of storage stability at ambient temperature.

Thus, without resorting to any post-crystallization process such as grinding, milling, jet milling and the like, small crystal size and acceptably stable crystalline as well as amorphous TGS was obtained in this invention. This process is a batch process, far simpler to control and more efficient than the method of Catani et al (2005) which is an essentially continuous process and not a batch process, and the one reported by Ratnam et al (2005) for achieving stable TGS.

Without being bound to any particular theory, it is believed that when TGS having good solubility in a polar alcoholic solvent such as methanol is also having a less polar organic solvent such as butanol in which TGS is moderately soluble at high temperature but less soluble at lower temperatures and TGS is present near its saturation level in such a solvent mixture where the proportion of the less polar organic solvent is predominant, and further crystallization is induced by lowering of temperature of the saturated mixture, if rate of cooling is such that new crystals are formed without giving a chance for already formed crystals to grow, more number of crystals will be formed and TGS shall get consumed below critical level before the earliest formed crystal has grown beyond a certain limit. This theory also explains the observation that instead of butanol, if ethyl acetate is used in a two solvent system containing methanol, crystallizing out itself starts very late and more slowly and for achieving same size of small crystals, far longer period is required, and hence longer duration of cooling to get same yield of crystals.

In other words, when this mixture of solvents of this invention containing TGS is subjected to distillation, the relative proportions of polar alcoholic solvent to the less polar organic solvent changes and hence the solubility of TGS in the solution also changes. When the methanol is progressively removed along with substantial quantity of n-butanol, the solubility of TGS in the solution decreases and the falling out of the TGS as crystals starts.

The use of amorphous forms in formulations have their own advantages such as better flow properties leading to easier material handling during application as an ingredient and mixing.

The examples described below serve as illustration on how to practice the invention claimed in this specification and do not limit the scope of actual techniques used or scope of or range of reaction conditions or process conditions claimed. Several other adaptations of the embodiments in the context of method for direct crystallization resulting in small particle size and production of an amorphous form will be easily anticipated by those skilled in this art and they are also included within the scope of this work. Mention of a singular also includes pleural of the same unless context does not permit so. Thus a mention of “a solvent” also includes more than one solvent. Equivalent alternatives of a reactant or a reaction condition are also included within the scope of claims of this specification. Thus, mention of “a less polar organic solvent” in the context of polar alcoholic solvents includes one or more of ethyl acetate, n-propanol, Iso butanol, t-butanol, secondary butanol, pentanol, Amyl alcohol, and the like if they can perform same function, if used as an alternative chemical. Similarly, a mention of “an ester of sucrose” includes in it monoester as well as pentaesters and their derivatives. In general, any modification or an equivalent obvious to a person skilled in the art is included within the scope of this specification and its claims.

In another process described is a drying technique applied directly to the pure eluent obtained from the Affinity chromatography process. These drying techniques could be one or more of a spray drying, an Agitated thin film drying, drying in forced circulation evaporators, etc. Here the TGS in alcoholic solvent mixtures such as methanol and butanol or other solvents such as n-propanol, Iso butanol, t-butanol, secondary butanol, pentanol, Amyl alcohol, etc. is subjected to any drying technique such as spray drying.

The spray dryer system should have a solvent recovery system to recover the solvent during the drying operation. The inlet temperature of the spray drier was adjusted to 160-200° C. more preferably 180-185° C. The solid obtained from the spray drier outlet and cyclonic separator was found to be amorphous in nature. The purity of the product was not altered during the drying operation.

It was seen that the amorphous form of product obtained was much smaller in particle size as compared to the crystallized product. The amorphous product particle size of 90% composition was found to be less than 6 microns as against 10 microns in the crystallized product

It is pertinent to note that products prepared by process of this invention pass the JECFA (Joint Expert Committee on Food Additives) specifications in all the respects, including methanol and residual solvent (the residual solvent is under organic volatile which should match the ICH guidelines content (see table 5).

As the table 4 shows that the amorphous form of TGS is much more stable when compared to the crystalline form.

The crystalline TGS of particle size of this invention as well as amorphous TGS of particle size of this invention may be used as an ingredient in pharmaceuticals or consumables and such compositions are also included in the scope of this invention.

It may be appreciated by any one skilled in the art that solutions of TGS as mentioned above in the solvents specified or equivalent may be obtained by methods other than affinity chromatography, and all such embodiments are included within the scope of this invention.

### EXAMPLE 1

### Chlorination of 6-acetyl Sucrose Using Thionyl Chloride and Subsequent Purification

69 kg of Thionyl chloride was added dropwise to 165 kg of DMF taken in a Glass Lined Reactor. 6 kg of charcoal was added to the reaction mass and nitrogen sparing was started in the reactor. The temperature was controlled below 40° C. The mass was then cooled to 0° C. and 30 kg of 6-acetyl sucrose in DMF was added and the temperature was controlled below 5° C. After the completion of addition of 6-acetyl sucrose, the temperature of the mass was taken up to 30° C. and maintained for 60 minutes under stirring.

Then the mass was heated to 85° C., maintained for 60 minutes, again heated to 100° C. and maintained for 6 hours. Then the mass was further heated to 114° C. and maintained for 90 minutes and cooled to 60° C.

Then the mass was neutralized in 8% ammonia solution up to pH 7.0. The 6-acetyl TGS was analyzed in the neutralized mass and was found to be 62% of 6-acetyl sucrose input.

The mass was then filtered to remove the extraneous solids from the neutralized mass. The mass was then loaded on to ADS 600 resin obtained from Thermax. The chlorinated acyl derivatives of sucrose was adsorbed on to the resin and the DMF along with solubilized inorganic salts passed out of the column. Then the resin was washed with demineralized water and then the 6-acetyl TGS was eluted out with 90% methanol and 10% of 25% ammonia solution. The 6-acetyl TGS as it was eluting out of the column, the deacylation of 6-acetyl TGS to TGS also happened in situ and the TGS fractions were collected separately.

The TGS fractions were then neutralized using dilute HCl and was taken for concentration to remove methanol and the syrup obtained was diluted in water up to a TGS concentration of 3%. This mass was then again passed through the ADS 600 resin (obtained from Thermax) packed in a SS column. The pure TGS was adsorbed on to the column and the water was allowed to pass out of the column. The hold up water found in the resin column was then forced out by air pressure. Then mixture of methanol and butanol in 1:1 proportion was passed through the column and the TGS was eluted out from the resin.

The TGS in 1:1 methanol and butanol was taken for crystallization of TGS.

### EXAMPLE 2

### Crystallization of TGS in Methanol:n-butanol 1:1 Mixture with Small Particle Size

200 L of the in methanol-butanol (1:1) mixture containing 18 kg TGS dissolve in it was taken in a reactor. 200 g of pharma grade charcoal was added to the contents in the reactor and heated to 55-60° C. under stirring for 30 minutes. Then the solution was filtered to make it free from charcoal and extraneous matter. The filtrate was then subjected to concentration under vacuum below 55° C. till the TGS concentration reached to 55%. Some amount of crystals of TGS started appearing during this stage.

The reactor was equipped with a control system to facilitate gradual cooling of the TGS solution. The solution was cooled from 55° C. to 30° C. in about 4-6 hours, then from 30° C. to 15° C. in about 2 hours and then further cooled to −5° C. in about 3.5 hours. The crystal slurry was then filtered and suck dried.

The wet solids obtained were then re-slurried in 5 L of ethyl acetate and stirred for 30 minutes at −5° C. Then the slurry was filtered and suck dried. Further the solids were dried in Vacuum Tray drier below 45° C.

The TGS crystals obtained were tested for purity and particle size. The purity was found to be 99.23% by HPLC and particle size distribution at 90% is below 10 microns and mean particle size is 4.2 micron. The overall yield from the process was found to be 80%. The mother liquor from the process was recycled.

### EXAMPLE 3

### Chlorination of 6-benzoyl Sucrose and Subsequent Purification and Isolation of TGS in Amorphous Form with Small Particle Size

54 kg of Phosphorus Pentachloride was added to 135 kg of DMF taken in a Glass Lined Reactor. The temperature was controlled below 20° C. After the addition of PCl₅ the mass was stirred for 60 minutes to allow the Vilsmeier-Haack reagent to form. The by-product POCl₃ generated formed the second Vilsmeier in situ in the reaction mass with the excess DMF available. The mass was then cooled to 0° C. and 30 kg of sucrose-6-benzoate in DMF was added and the temperature was controlled below 5° C. After the completion of addition of sucrose-6-benzoate, the temperature of the mass was taken up to 30° C. and maintained for 60 minutes under stirring.

Then the mass was heated to 85° C., maintained for 60 minutes, again heated to 100° C. and maintained for 6 hours. Then the mass was further heated to 114° C. and maintained for 90 minutes and cooled to 60° C.

Then the mass was neutralized in 50% calcium hydroxide slurry in water up to pH 7.0. The 6-benzoyl TGS was analyzed in the neutralized mass and was found to be 45% of sucrose-6-benzoate input.

The mass was then filtered to remove the extraneous solids from the neutralized mass. The mass was then loaded on to ADS 600 resin obtained from Thermax. The chlorinated derivatives of sucrose was adsorbed on to the resin and the DMF along with solubilized inorganic salts passed out of the column. Then the resin was washed with demineralized water and then the 6-benzoyl TGS was eluted out with 90% methanol and 10% of 25% ammonia solution. The 6-benzoyl TGS as it was eluting out of the column, was debenzoylated in situ and TGS fractions were collected separately.

The TGS fractions were then neutralized using dilute HCl and was taken for concentration to remove methanol and the syrup obtained was diluted in water up to a TGS concentration of 3%. This mass was then again passed through the ADS 600 resin (obtained from Thermax) packed in a SS column. The pure TGS was adsorbed on to the column and the water was allowed to pass out of the column. The hold up water found in the resin column was then forced out by air pressure. Then 1:1 of methanol and Isopropanol mixture was passed through the column and the TGS was eluted out from the resin.

10 kg of TGS eluted from Affinity chromatography resin columns in 200 L of 1:1 Isopropanol and methanol was taken for spray drying.

The spray drier was equilibrated setting the inlet temperature to 182° C. and peristaltic pump flow rate to 30 L per hour. The inlet was DM water, which was switched on to the above said TGS feed. As the Isopropanol and methanol mixture was atomized into thin droplets on to the spray drier top chamber, the fine powder of TGS started collecting in the chamber end and the fines were collected from the cyclonic separator.

The solids obtained were tested for purity, particle size and X ray diffraction for the nature of solid obtained. The purity was found to be 99.28% and particle size distribution at 90% was below 6 microns. The overall yield from the process was found to be 86%. The nature of the crystals as per X-ray crystallography showed no peaks confirming the product to be amorphous in nature.

### EXAMPLE 4

### Crystallization of TGS from Methanol:Butanol with Large Particle Size

1.0 kg of TGS obtained after affinity column chromatographic purification was taken for crystallization.

20 L of the TGS in methanol-butanol mixture was taken in a reactor.

200 g of pharma grade charcoal was added to the contents in the reactor and heated to 55-60° C. under stirring for 30 minutes. Then the solution was filtered to make it free from charcoal and extraneous matter. The filtrate was then subjected to concentration under vacuum below 55° C. till the TGS concentration reached to 55%. Some amount of crystals of TGS started appearing during this stage.

The reactor was equipped with a control system to facilitate gradual cooling of the TGS solution. The solution was cooled from 55° C. to 30° C. in about 8-10 hours, then from 30° C. to 15° C. in about 4 hours and then further cooled to −5° C. in about 6 hours. The crystal slurry was then filtered and suck dried.

The wet solids obtained were then re-slurried in 5 L of ethyl acetate and stirred for 30 minutes at −5° C. Then the slurry was filtered and suck dried. Further the solids were dried in Vacuum Tray drier below 45° C.

The TGS crystals obtained were tested for purity and particle size. The purity was found to be 99.67% by HPLC, largest particle size was about −150 . . . microns, 90% was below about . . . 95 . . . microns. The overall yield from the process was found to be 72%.

### EXAMPLE 5

### Crystallization of TGS in Methanol:Ethyl Acetate (1:1) with Large Particle Size

18 L of methanol containing 1.0 kg of TGS was taken in a reactor.

200 g of pharma grade charcoal was added to the contents in the reactor and heated to 55-60° C. under stirring for 30 minutes. Then the solution was filtered to make it free from charcoal and extraneous matter. The filtrate was then subjected to concentration under vacuum below 55° C. till the TGS concentration reached to 50%. 1:2 times of ethyl acetate was added at this stage and some amount of crystals of TGS started appearing during this stage.

The reactor was equipped with a control system to facilitate gradual cooling of the TGS solution. The solution was cooled from 55° C. to 30° C. in about 18 hours, then from 30° C. to 15° C. in about 16 hours and then further cooled to −5° C. in about 3 hours. The crystal slurry was then filtered and suck dried.

The wet solids obtained were then re-slurried in 5 L of ethyl acetate and stirred for 30 minutes at −5° C. Then the slurry was filtered and suck dried. Further the solids were dried in Vacuum Tray drier below 45° C.

The TGS crystals obtained were tested for purity and particle size. The purity was found to be 98.6% by HPLC and particle size distribution at 90% was below 240 microns. The overall yield from the process was found to be 81%.

### EXAMPLE 6

### Crystallization of TGS in Methanol:Ethyl Acetate with Small Particle Size

18 L of methanol containing 1.0 kg of TGS was taken in a reactor.

200 g of pharma grade charcoal was added to the contents in the reactor and heated to 55-60° C. under stirring for 30 minutes. Then the solution was filtered to make it free from charcoal and extraneous matter. The filtrate was then subjected to concentration under vacuum below 55° C. till the TGS concentration reached to 50%. 1:2 times of ethyl acetate was added at this stage and some amount of crystals of TGS started appearing during this stage.

The reactor was equipped with a control system to facilitate gradual cooling of the TGS solution. The solution was cooled from 55° C. to 30° C. in about 16 hours, then from 30° C. to 15° C. in about 6 hours and then further cooled to −5° C. in about 60 minutes. The crystal slurry was then filtered and suck dried.

The wet solids obtained were then re-slurried in 5 L of ethyl acetate and stirred for 60 minutes at −5° C. Then the slurry was filtered and suck dried. Further the solids were dried in Vacuum Tray drier below 45° C.

The TGS crystals obtained were tested for purity and particle size. The purity was found to be 99.4% by HPLC and particle size distribution at 90% was below 12 microns. The overall yield from the process was found to be 76%.

### EXAMPLE 7

### Accelerated Stability Test

Stability testing done as per ICH Harmonised Tripartite Guideline “Stability Testing of New drug substances and Products, Q1AR2” for crystalline TGS of this invention as well as amorphous form have shown that they pass the stability test. Details are given on table nos 1 to 4 given in the following:

TABLE 1
Storage condition: 25° C. ± 2° C. 60%
RH ± 5% RH (Crystalline TGS small particle size)

| | | Label | | | |
|---|---|---|---|---|---|
| | | Appearance | Specific Rotation | Water content | Assay |
| | Actual | Normal | +84° to +87.5° C. | NMT 2% | 98 to 102% |
| INITIAL | Dates | Normal | +86.07° | 0.52% | 99.70% |
| 1^{st} month | 14 Jan. 2005 | Normal | +85.99° | 0.73% | 99.02% |
| 2^{nd} month | 14 Feb. 2005 | Normal | +84.63° | 0.63% | 99.04% |
| 3^{rd} month | 14 Mar. 2005 | Normal | +85.31° | 0.22% | 99.05% |
| 4^{th} month | 14 Apr. 2005 | Normal | +84.20° | 0.41% | 99.36% |
| 5^{th} month | 14 May 2005 | Normal | +87.22° | 0.17% | 98.42% |
| 6^{th} month | 14 Jun. 2005 | Normal | +86.78° | 0.23% | 99.07% |
| 12^{th} month | 14 Dec. 2005 | Normal | +85.93° | 0.33% | 99.02% |
| 24^{th} month | 14 Dec. 2006 | Normal | +84.63° | 0.53% | 98.78% |

TABLE 2
Storage condition: 30° C. ± 2° C. 65%
RH ± 5% RH (Crystalline TGS small particle size)

| | | Label | | | |
|---|---|---|---|---|---|
| | | Appearance | Specific Rotation | Water content | Assay |
| | Actual | Normal | +84° to +87.5° C. | NMT 2% | 98 to 102% |
| INITIAL | Dates | Normal | +86.07° | 0.52% | 99.70% |
| 1^{st} month | 14 Jan. 2005 | Normal | +86.01° | 0.69% | 99.84% |
| 2^{nd} month | 14 Feb. 2005 | Normal | +85.11° | 0.19% | 99.34% |
| 3^{rd} month | 14 Mar. 2005 | Normal | +86.29° | 0.28% | 100.62% |
| 4^{th} month | 14 Apr. 2005 | Normal | +86.67° | 0.24% | 99.95% |
| 5^{th} month | 14 May 2005 | Normal | +87.58° | 0.18% | 99.88% |
| 6^{th} month | 14 Jun. 2005 | Normal | +84.35° | 0.42% | 99.43% |
| 12^{th} month | 14 Dec. 2005 | Normal | +85.62° | 0.66% | 99.32% |
| 24^{th} month | 14 Dec. 2006 | Normal | +86.73° | 0.70% | 98.82% |

TABLE 3
Storage condition: 40° C. ± 2° C. 75%
RH ± 5% RH (Crystalline TGS small particle size)

| | | Label | | | |
|---|---|---|---|---|---|
| | | Appearance | Specific Rotation | Water content | Assay |
| | Actual | Normal | +84° to +87.5° C. | NMT 2% | 98 to 102% |
| INITIAL | Dates | Normal | +86.07° | 0.52% | 99.70% |
| 1^{st} month | 14 Jan. 2005 | Normal | +86.01° | 0.73% | 99.06% |
| 2^{nd} month | 14 Feb. 2005 | Normal | +86° | 1.10% | 99.04% |
| 3^{rd} month | 14 Mar. 2005 | Normal | +85.16° | 0.27% | 99.67% |
| 4^{th} month | 14 Apr. 2005 | Normal | +85.81° | 0.22% | 99.12% |
| 5^{th} month | 14 May 2005 | Normal | +85.74° | 0.20% | 98.96% |
| 6^{th} month | 14 Jun. 2005 | Normal | +82.67° | 0.49% | 98.82% |
| 12^{th} month | 14 Dec. 2005 | Normal | +86.01° | 0.73% | 98.75% |
| 24^{th} month | 14 Dec. 2006 | Normal | +86° | 1.10% | 98.52% |

TABLE 4
Storage condition: (Amorphous TGS small particle size)

| | | Label | | | |
|---|---|---|---|---|---|
| | | | Assay | | |
| | | Appearance | | | 40° C. ± 2° C. |
| | Actual | Normal | 25° C. ± 2° C. | 30° C. ± 2° C. | 75% RH ± 5% RH % |
| INITIAL | Dates | Normal | 60% RH ± 5% RH | 65% RH ± 5% RH | 99.70% |
| 1^{st} month | 14 Jan. 2005 | Normal | 99.34% | 99.84% | 99.68% |
| 2^{nd} month | 14 Feb. 2005 | Normal | 99.36% | 99.84% | 99.65% |
| 3^{rd} month | 14 Mar. 2005 | Normal | 99.32% | 99.62% | 99.67% |
| 4^{th} month | 14 Apr. 2005 | Normal | 99.36% | 99.65% | 99.58% |
| 5^{th} month | 14 May 2005 | Normal | 99.28% | 99.58% | 99.52% |
| 6^{th} month | 14 Jun. 2005 | Normal | 99.23% | 99.53% | 99.46% |
| 12^{th} month | 14 Dec. 2005 | Normal | 99.22% | 99.62% | 99.52% |
| 24^{th} month | 14 Dec. 2006 | Normal | 99.14% | 99.32% | 99.12% |

### EXAMPLE 8

Crystalline TGS and amorphous TGS prepared by process of this invention was analysed and was found to pass the JECFA specifications. Details are given in following table No. 5

TABLE 5

| | JECFA | Crystalline | Amorphous |
|---|---|---|---|
| TEST | SPECIFICATION | TGS | TGS |
| Description | White to off | White to off | White to off |
| | white crystals, | white crystals, | white crystals, |
| | taste sweet. | taste sweet. | taste sweet. |
| Solubility | Soluble in | Soluble in | Soluble in |
| | ethanol and | ethanol and | ethanol and |
| | water. Slightly | water. Slightly | water. Slightly |
| | soluble in ethyl | soluble in ethyl | soluble in ethyl |
| | acetate. | acetate. | acetate. |
| Specific Rotation | Between +84° | +85.6° | +84.9° |
| | to +87.5° | | |
| Water content | NMT 2% | 0.2% | 0.05% |
| Sulphated ash | NMT 0.7% | 0.1% | 0.1% |
| Identification | Complies with | Complies with | Complies with |
| by IR | standard. | standard. | standard. |
| Identification | Rf should complies | Rf complies | Rf complies |
| by TLC | with std | with std | with std |
| Other chlorinated | NMT 0.5% | NMT 0.5% | NMT 0.5% |
| disaccharides | | | |
| Chlorinated | NMT 0.1% | NMT 0.1% | NMT 0.1% |
| monosaccharides/ | | | |
| Hydrolysis of | | | |
| product | | | |
| Methanol | NMT 0.1% | 0.02% | 0.01% |
| Purity | NLT 98% | 98.9% | 99.1% |
| Arsenic | NMT 3 ppm | NMT 3 ppm | NMT 3 ppm |
| Heavy metals | NMT 0.001% | NMT 0.001% | NMT 0.001% |

### EXAMPLE 9

### Accelerated Stability Testing

Crystalline TGS of Mean Particle Size (MPS) of about 35 micron (big particle size) was achieved by crystallization from ethyl acetate system and Crystalline TGS of Mean Particle Size (MPS) of about 4.2 micron (small particle size) was achieved by crystallization from butanol methanol system, the amorphous form having about 3 micron average particle size was achieved by spray drying as described above and an accelerated stability testing was carried out. All the three samples were taken in sealed containers and were incubated at 50° C. Crystalline samples were analyzed for purity as well as pH for 6 days and the amorphous sample was analysed for three days and the results obtained are as follows.

TABLE 6
Crystalline TGS crystallized from Ethyl acetate:methanol mixture
as described in Example 5 i.e. large Mean Particle Size (MPS)

| Sample Name | Assay (%) | PH |
|---|---|---|
| First day - 35μ MPS | 98.73 | 7.08 |
| Second day - 35μ MPS | 98.21 | 7.08 |
| Third day - 35μ MPS | 97.53 | 7.02 |
| Fourth day - 35μ MPS | 97.06 | 7.00 |
| Fifth day - 35μ MPS | 96.86 | 7.00 |
| Sixth day - 35μ MPS | 96.72 | 7.02 |

TABLE 7
Crystalline TGS crystallized from butanol:methanol mixture as
described in Example 2 i.e. Small Mean Particle Size (MPS)

| Sample Name | Assay (%) | PH |
|---|---|---|
| First day - 2.52μ MPS | 99.2 | 7.90 |
| Fourth day - 2.52μ MPS | 99.12 | 7.62 |

TABLE 8
Amorphous TGS. Smallest Mean Particle Size.

| Sample Name | Assay (%) | PH |
|---|---|---|
| First day - 4.2μ MPS | 98.21 | 7.03 |
| Second day - 4.2μ MPS | 98.20 | 7.03 |
| Third day - 4.2μ MPS | 98.24 | 7.02 |
| Fourth day - 4.2μ MPS | 98.18 | 7.02 |
| Fifth day - 4.2μ MPS | 98.19 | 7.06 |
| Sixth day - 4.2μ MPS | 98.17 | 7.05 |

The results show that assay of large particle size crystalline TGS declined by 1.2% in first three days and by 2.01% by sixth day; difference in pH was not substantial. In small particle size crystalline TGS, percent assay as well as pH were stable. This indicated enhanced stability for small particle size crystalline TGS. The amorphous form, which had least average particle size of about 3 micron, showed excellent stability wherein in three days, decline in percent assay was 0.08% and decline in pH was by 0.08 units.

1. Crystalline 4,1′,6′ Trichlorogalactosucrose (TGS) having enhanced storage stability, a mean particle size of about 5 microns or less, 90% particles being less than about 10 microns and the maximum particle size being more than twice the mean but less than about 35 microns.

2. Solid amorphous Trichlorogalactosucrose (TGS) form having enhanced storage stability, a mean particle size of at most about 3 microns or less, 90% particles being less than about 5 microns and the maximum particle size being more than twice the mean but less than about 15 microns.

3. A process of producing crystalline 4,1′,6′ Trichlorogalactosucrose (TGS) having enhanced storage stability comprising one or more of following steps:
a. achieving a saturated solution of TGS at about 45-55° C. in a mixture of a polar alcoholic solvent and a less polar organic solvent, the proportion of the said polar alcoholic solvent being within a range of about 3% to 10% of total volume of the said saturated solution
b. decreasing temperature of the said saturated solution of TGS from a temperature of about 55° C. up to about −5° C. at a time interval adjusted to get crystalline TGS having small particle size accompanied, whenever needed, by addition of more of the polar alcoholic solvent to keep its proportion above at least about 3% up to about 10%; the said small particle size being defined as a mean particle size of about 5 microns or less, 90% particles being close to 10 microns or less and maximum particle size being less than about 35 microns,
a. optionally washing the crystalline TGS slurry with an ester solvent, separation of the wash solvent, and
b. drying the crystals.

4. A process of claim 3 wherein:
a. the said polar alcoholic solvent comprises one or more of a methanol, ethanol and the like,
b. the said less polar organic solvent comprising one or more of ethyl acetate, n-propanol, Iso-butanol, t-butanol, secondary butanol, pentanol, amyl alcohol, and the like,
c. the said organic solvent comprises one or more of ethyl acetate, butyl acetate, acetone, methyl ethyl ketone, Methylene dichloride, and the like.

5. A process of claim 4 wherein:
a. a solution of TGS, preferably around about 5%, in a mixture of methanol and butanol taken preferably in 1:1 proportion is concentrated under reduced pressure at a preferred temperature of about 55° C. to get a mixture saturated with TGS in butanol containing about 3% to about 10% methanol and TGS starts crystallizing out,
b. temperature of the mixture is thereafter cooled from 55° C. preferably to 30° C. preferably in about 4-6 hours, then from 30° C. preferably to 15° C. in preferably about 2 hours and then further cooled preferably to −5° C. preferably in about 3.5 hours,
c. crystal slurry is then filtered and suck dried,
d. wet solids obtained are then re-slurried −5° C. in ethyl acetate and stirred for a period of time, preferably for 30 minutes, and
e. the slurry was filtered, suck dried followed by further drying preferably in a Vacuum Tray drier at a preferred temperature below 45° C.

6. A process of claim 5 wherein the said solution of TGS in a mixture of methanol:Butanol is an eluted out solution from an affinity chromatography column packed in an adsorbent on which TGS was adsorbed and the eluted out solution is further purified by addition of charcoal to remove impurities.

7. A process of claim 6 when the said preferred absorbent is ADS 600 resin obtained from Thermax.

8. A consumable or pharmaceutical composition containing crystalline TGS of claim 1.

9. A consumable or pharmaceutical composition position containing amorphous TGS of claim 2.
